(19) United States
(12) Patent Application Publication
(10) Pub. No.: US 2019/0075774 A1
(43) Pub. Date: Mar. 14, 2019

(54) INSECT LIGHT TRAP

(71) Applicant: RENTOKIL INITIAL 1927 PLC, Blackwater (GB)

(72) Inventors: Michael BEST, Totton Southampton (GB); Victoria RANDS, Wilton Salisbury (GB); Gary WINGETT, Totton Southampton (GB)

(21) Appl. No.: 16/185,719

(22) Filed: Nov. 9, 2018

Related U.S. Application Data
(63) Continuation of application No. PCT/GB2017/053494, filed on Nov. 21, 2017.

(30) Foreign Application Priority Data
Nov. 21, 2016 (GB) 1619672.7

(51) Int. Cl. A01M 1/04; A01M 1/10; F21V 14/08

(52) U.S. Cl. CPC A01M 1/04; A01M 1/14; F21V 14/08; A01M 1/106

(57) ABSTRACT

An insect light trap comprising a housing, the housing having an aperture, and a light source inside the housing for emitting insect attracting light through the aperture, wherein the housing has a movable panel movable between at least a position and a second position in which it obstructs, or guides, the light from the light source passing through the aperture differently from in the first position. The insect light trap further comprises an actuator mounted to move the movable panel between the said positions in response to a control signal a first light level sensor connected to provide a light level signal indicating a light level received by sensor from the surroundings of the insect light trap a control circuit connected to receive the first light level signal and responsive thereto to provide the control signal to the actuator to move the panel.

### CROSS-REFERENCE TO RELATED APPLICATIONS

This Application is a continuation of PCT International Application PCT/GB2017/053494, filed on Nov. 21, 2017, which claims priority to GB Application No. 1619672.7, filed on Nov. 21, 2016. The contents of the aforementioned applications are herein incorporated by reference in their entirety.

### BACKGROUND

Insect light traps are used for example in restaurants, food shops, and food production factories to control insects, particularly flying insects. Known insect light traps typically comprise a housing mountable on a wall, a light source (often an ultra-violet tube lamp) for attracting the insects to the trap and apparatus for killing and capturing the insects (for example a glueboard or alternatively an electric grid and collection tray). The light source is usually mounted inside the housing, which has apertures, for example provide by a metal grille, to allow the light generated out into the surrounding environment, where it is seen by the insects who are attracted to it, fly into the trap and are caught.

### BRIEF SUMMARY

According to a first aspect of the invention there is provided an insect light trap comprising: a housing, a light source inside the housing for emitting insect attracting light, wherein the housing has at least one first aperture allowing insect attracting light from the light source to pass out of the housing and has a second aperture, and wherein the housing comprises a light optimization panel movable between first position in which it obstructs at least part or all of the second aperture from passing insect attracting light from the light source out of the housing and a second position in which it obstructs a lesser part than in the first position, or none of the second aperture, from passing insect attracting light from the light source out of the housing.

The light source may be an ultra-violet (UV) light source or may be a visible light source.

The at least one first aperture may be a plurality of apertures divided by one or more louvres.

The at least one first aperture may be in the front of the insect light trap.

The second aperture may be in one of a top side, a left or right side or a bottom side of the housing.

The second aperture may be in a top side of the housing.

The light optimization panel may be removable from the second aperture. The light optimization panel may be hinged to move between the first and second positions, or may be a sliding panel mounted to slide between the first and second positions.

The insect light trap may comprise an actuator coupled to the light panel to move it between the first and second positions.

The light source may be an ultra violet (UV) light source, and may comprises UV light emitting diodes (LEDs).

A second aspect of the invention provides an insect light trap comprising: a housing, the housing having an aperture, and a light source inside the housing for emitting insect attracting light through the aperture, wherein the housing has a movable panel movable between at least a position and a second position in which it obstructs, or guides, the light from the light source passing through the aperture differently from in the first position, the insect light trap further comprising: an actuator mounted to move the movable panel between the said positions in response to a control signal, a first light level sensor connected to provide a light level signal indicating a light level received by sensor from the surroundings of the insect light trap, a control circuit connected to receive the first light level signal and responsive thereto to provide the control signal to the actuator to move the panel.

The panel may comprise one or more louvres. The panel may comprise two or more louvres.

The aperture and the panel may be in the front of the insect light trap.

The aperture and the panel may be in a top side, a left or right side, or a bottom side of the insect light trap.

The insect light trap may have an aperture in a front side of the insect light trap allowing light from the light source to pass out of the insect light trap.

The light source may be an ultra violet (UV) light source.

The first light level sensor may be a visible light level sensor and provide a light level signal indicating a visible light level.

The first light level sensor may be an ultra violet (UV) light level sensor and provide a light level signal indicating a UV light level.

The insect light trap may comprise a second light level sensor connected to provide a light level signal indicating a light level received by sensor from the surroundings of the insect light trap, and to which the control circuit is responsive to provide the control signal to the actuator to move the panel.

A third aspect of the invention provides an insect light trap comprising: a housing, a light source inside the housing for emitting insect attracting light, wherein the housing comprising at least one louvre defining a plurality of first apertures allowing insect attracting light from the light source to pass out of the housing.

The at least one louvre may be a plurality of louvres and the louvres may be angled to the vertical and overlap and obscure the light source from view when viewed from a position below the insect light trap.

Each louvre may have a major face with the angle between that face and the vertical being 30°.

The number of louvres may be four, or may be three.

The at least one louvre may be each mounted to swivel. The at least one louvre may be each mounted to swivel about a horizontal axis.

The third aspect of the invention also provides a method of adjusting the insect light trap comprising the step of: adjusting the angle of the louvres so that they overlap and obscure the light source from view when viewed from a selected position.

The selected position may be below the insect light trap.

The third aspect of the invention further provides a method of installing the insect light trap comprising: mounting the insect light trap on a wall, and adjusting the insect light trap according to the method above.

The mounting may comprise mounting the insect light trap so that its bottom is above 1.8 m above a floor adjacent the wall.

A fourth aspect of the invention provides an insect light trap comprising: a housing, a light source inside the housing for emitting insect attracting light, a first light level sensor connected to provide a light level signal indicating a light level received by the sensor from the surroundings of the insect light trap, a control circuit connected to receive the first light level signal and responsive thereto to control the power output of the light source.

The first light level sensor may sense visible light and may be connected to provide a light level signal indicating the visible light level received by the sensor.

The first light level sensor may sense ultra-violet (UV) light and may be connected to provide the light level signal indicating the UV light level received by the sensor.

The insect light trap may comprise a second light level sensor connected to provide a light level signal indicating a light level received by the second sensor from the surroundings of the insect light trap, wherein the second light level sensor senses ultra-violet (UV) light and is connected to provide its light level signal indicating the UV light level received by the second sensor, and wherein the first and second light level sensors are mounted on the insect light trap to receive UV light from different parts of the surroundings of the insect light trap and the control circuit is connected to receive the first and second light level signals and is responsive to the first and second light level signals to control the power output of the light source.

The light source may be an ultra-violet (UV) light source.

A fifth aspect of the invention provides an insect light trap comprising: a housing, a light source inside the housing for emitting insect attracting light, a light level sensor mounted to have a view of the inside of the housing and connected to provide a light level signal indicating a light level received by sensor from the light source, and a control circuit connected to receive the light level signal and responsive thereto to control the light level output by the light source.

The control circuit may be responsive to the light level signal to control the light level output by the light level output by the light source to a target level.

The control circuit may be arranged to provide the light source with a particular level of drive and to record the level from the sensor produced thereby, and to use the recorded level, or a level derived therefrom, as the target level in subsequent operation.

The control circuit may comprise a look up table and may be arranged from time to time to set the level of drive of the light source with a test level of drive and to record the level of light signal in that condition, and may be arranged to look up a drive level, in the table, corresponding to the recorded light level signal, to set the level of drive to that drive level in subsequent operation.

The light source may be an ultra violet light source and the light source may comprise light emitting diodes (LEDs).

The light level sensor may be a UV light level sensor.

### BRIEF DESCRIPTION OF THE DRAWINGS

Embodiments of the invention will now be described, by way of example only, with reference to the accompanying drawings, of which:

FIG. 1 is a rear perspective view of an insect light trap according to a first embodiment of the invention;

FIG. 2a is a front perspective view of the trap of FIG. 1 with the end panel removed;

FIG. 2b is a cross-sectional side view of the trap of FIG. 2a;

FIG. 3 is a copy of FIG. 1 (but shows the trap in the different configuration);

FIGS. 4a and 4b are copies of FIGS. 2a and 2b (but show the trap in the different configuration);

FIGS. 5a and 5b show a first example of a mounting for the light optimization panel, in cross-section;

FIGS. 5c and 5d show a second example of a mounting of the light optimization panel, in cross-section;

FIGS. 5e and 5f show a third example of a mounting of the light optimization panel, in cross-section;

FIG. 5g shows a drive for an automatic sliding version of the panel;

FIGS. 6a and 6b show perspective front views of a second embodiment of the insect light trap of the invention, in first and second configurations respectively;

FIGS. 7a and 7b show perspective front views of third and fourth embodiments of the insect light trap of the invention;

FIGS. 7c and 7d are front perspective views of a fifth embodiment of the insect light trap of the invention;

FIG. 8 is a perspective view of a sixth embodiment of the of the insect light trap of invention; and

FIG. 9 is a graph showing the typical performance over time of a LED UV lamp against time.

### DETAILED DESCRIPTION

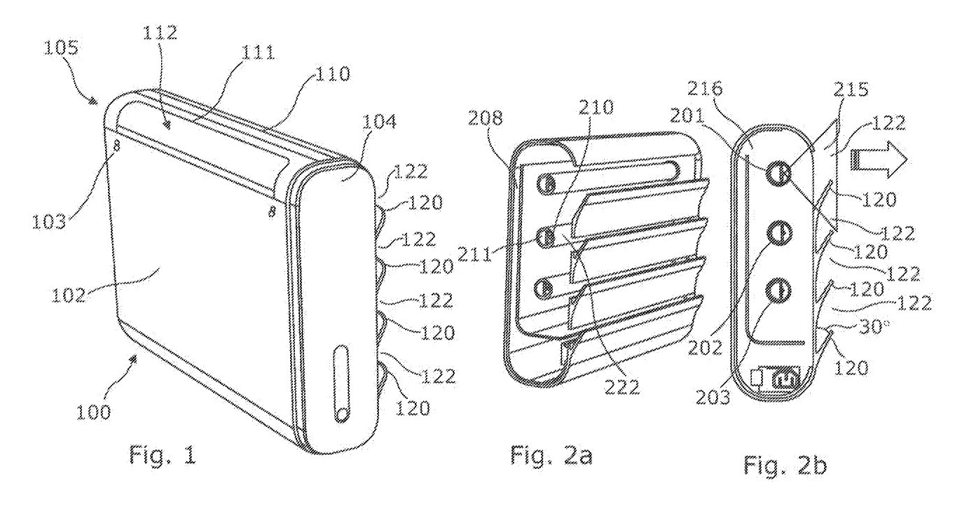

FIG. 1 shows a first embodiment of an insect light trap. This has a housing of which are visible in this view a rear panel 101, one 104 of two side panels 104 and 105 and a roof panel 110. Mounting holes 103 are provided in the back panel to allow the trap to be mounted on a wall of a room. Also just visible projecting in this view beyond the edge of side panel 104 are louvres 120 of a front panel of housing. The louvres have apertures 122 between them allowing light from a light source (not shown in FIG. 1) to shine out of the front of the housing to attract the insects. The light source may, for example, be a fluorescent tube lamp or a light emitting diode (LED) lamp, which may emit, for example, visible or UV light. The roof panel 110 has a portion having an aperture 111, which in the configuration shown is filled by a movable, light optimization panel 112.

FIGS. 2a and 2b show the same trap as FIG. 1, and in FIG. 2a, the end panel 104 is removed for the purpose of illustration. In these views, the louvres 120 and apertures 122 can be better seen. Inside the housing behind the louvres is the light source, in this example, three UV LED strip lamps 201, 201, 203 extending across the housing between the end panels, the lamps being in a column one above the next. Inside the housing is a mounting plate 208 with an L-shaped cross section, extending behind and below the lamps. Glueboards for capturing the insects attracted into the trap by the lamps are mounted on each of the vertical and horizontal portions of the mounting plate on the side facing the lamps.

The LEDs 210 of the lamps are mounted on a strip circuit board backed by an aluminum extrusion 211 installed inside a transparent tube 212. The LEDs project much of their light forward 215 towards the louvres. However, some of the light emitted in other directions 216 is reflected around inside the housing to emerge finally through the apertures between the louvres. To facilitate that the inside surface of the housing is coated with a reflective material.

In this example, the louvres are angled upward, when viewed from at least some positions below the louvres overlap so that one cannot see into the housing obscuring the view, in particular obscuring a direct view the light source. This protects people's eyes from the greatest concentrations of light from the light source, which is particularly important if a UV light source is being employed. A preferred angle between the louvres and the vertical is 30°. Typically, the insect light trap is mounted above 1.8 m above the floor. (1.8 m is the minimum height recommended to avoid eye exposure from the light source.)

In this example, the housing is made of a plastics material. Many plastics materials are damaged by UV light and a protective coating 220 is provided on the inside of the housing panels. In this example a single coating 220 of aluminum sputtering is provided, which doubles both to reflect the light from the lamps and protect the housing material. An alternative coating to do this is non-conductive vapor metallization (NCVM).

In FIGS. 2a and 2b, the light optimization panel 112 is in the same position as in FIG. 1. Light rays emitted by the light source are reflected from it by the coating 220 and many manage to escape through the apertures 122 between the louvres 120. The light optimization panel 112 prevents, however, the light from emerging through the aperture in the roof 111. Therefore, in this configuration the insect light trap provides its insect attracting illumination forward of itself through the apertures 112 in its front panel.

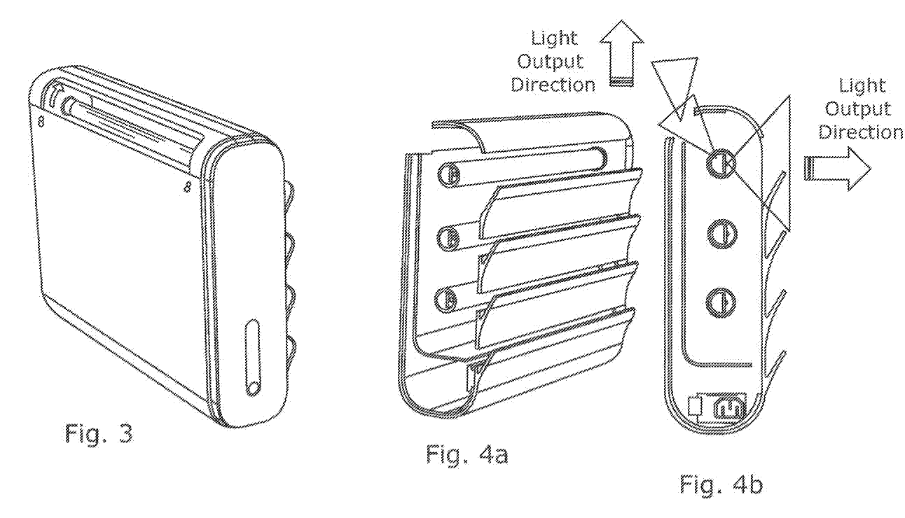

FIG. 3 shows, in a rear perspective view, the exemplary insect light trap with the roof panel 112 is removed leaving the aperture 111 open. Light from the light source therefore emerges through the aperture 111 in upward directions. When the trap is mounted on the wall this light illuminates the wall and the ceiling above providing further attraction for flying insects. As indicated by the large arrows in FIGS. 4a and 4b, which again show the exemplary insect light trap in front perspective (with end panel 104 removed) and in cross-section respectively, but in this configuration the trap provides insect attracting light in both forward and upward directions.

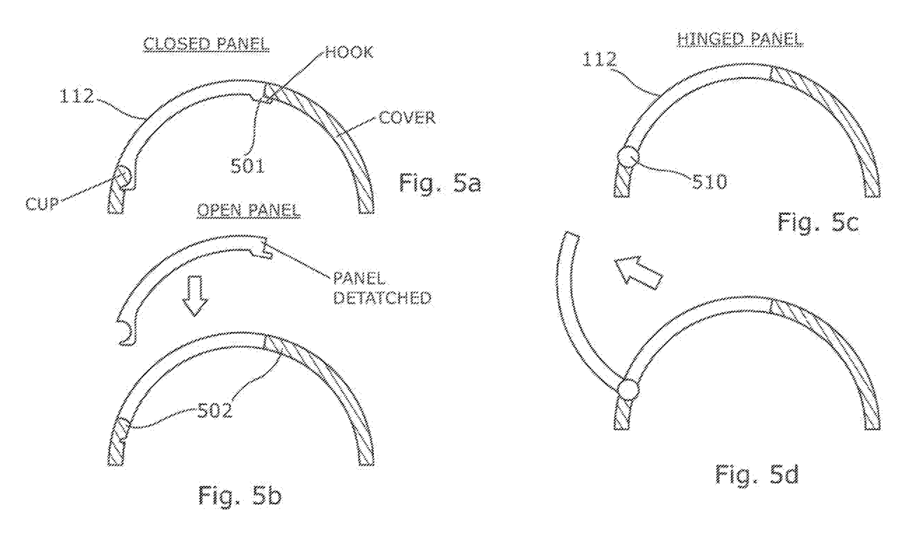

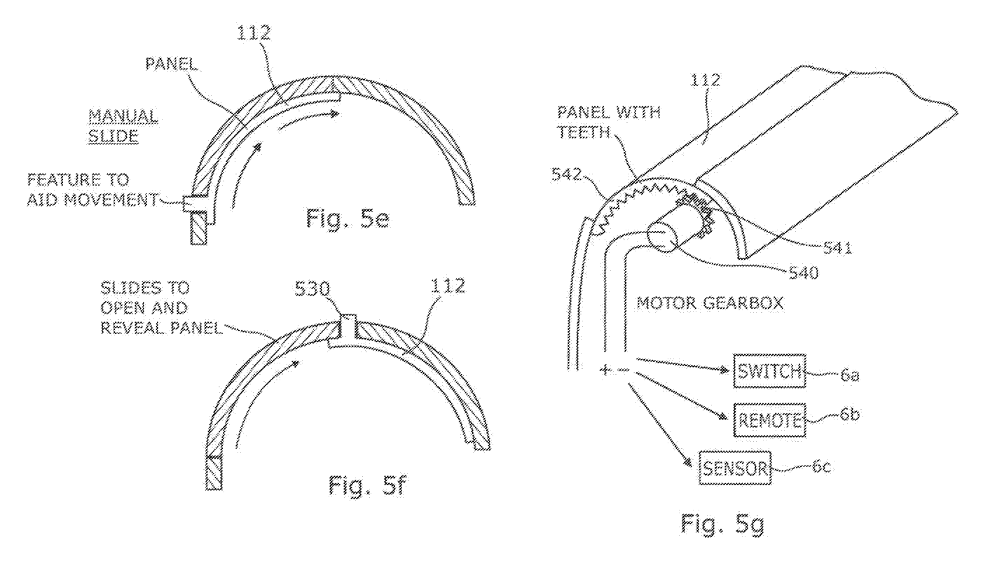

FIGS. 5a and 5b show a first example of a mounting for the light optimization panel 112, which is shown in position filling the aperture 111. These Figures are a cross-section through the panel 112 and the surrounding roof panel 110. In this example, the light optimization panel 112 has a flange 501 extending along the long edges of its perimeter that extends behind the edge of the roof panel beyond the edge of the aperture 111. With the face of the long edges of the aperture not being parallel, a plain flange is sufficient to retain the light optimization panel 112; however, in this particular example the roof panel has a trench 502 in the inside of the roof panel extending along the aperture 111 parallel to the long edges of the aperture, and the flange of the light optimization panel 112 is provided with a corresponding hook edge extending up into the trench. This provides a more secure fixing of the panel 112 in the aperture 115. FIG. 5b shows the light optimization panel entirely removed from the trap. To do this the light optimization panel is flexed while in the fitted position of FIG. 5a until the flange on one edge is clear of the edge of the aperture 111 and the panel is then passed out through the aperture 111. Without the light optimization in place in the aperture 111, the aperture 111 is open to allow light from the light source to be emitted upwards from the trap.

FIGS. 5c and 5d show a second example of a mounting of the light optimization panel 112. In this example, the panel 112 is mounted to the rear edge of the aperture 111 with a hinge 510. The panel is opened from the closed position filling the aperture 111, shown in FIG. 5c, to the open position shown in FIG. 5d with the panel extending upwards and the aperture open to allow light from the light source to be emitted upwards from the trap. In this particular example the hinge is inward of the back panel 102 of the trap and so when fully opened leans against either the wall to which the trap is mounted or against a final end stop provided by the construction of the hinge.

FIGS. 5e and 5f show a third example of a mounting of the light optimization panel 112. In this example, the panel is larger than the aperture 111, mounted behind and extending beyond the long edges of the aperture 111. The panel is provided with two slider pins at each of its ends (not shown) which project into trench guides (not shown), one in each end panel 104, 105. The panel 112 is provided with an outward projecting rib 530 close to one long edge of the panel extending parallel to that edge. In the closed position shown in FIG. 5e with the panel fully covering the aperture 111, so that light from the light source may not escape through it, the rib 530 rests against the edge of the aperture and so provides a stop limiting the motion of the panel 112. The rib is also used to slide the panel manually along the guide trenches in a direction generally parallel to the aperture, away to one side of the aperture. In this particular example, the other face of the rib 530 also provides a stop, as shown in FIG. 5f, when it engages the other long edge of the aperture.

A coating can be provided on one, other, or both of the surfaces of the contact surfaces between the light optimization panel and roof and/or trenches in the end panels, to aid the sliding. The aluminum sputtering and/or NCVM coatings mentioned above will also serve to do that.

FIG. 5g shows a drive for an automatic sliding version of the panel 112. This is generally as the example of FIGS. 5e and 5f but has an actuator, a motor 540, provided fixed to the end panel of housing. This drives a gear 541 that engages with a rack 542 provided on the underside of the panel. As the motor and gear turn, the rack advances taking the light optimization panel 112 with it, the panel thereby being moved to a position where it covers the aperture 111 or where it leaves the aperture open. In some embodiments, the motor is operated manually by closing a switch. In others, it is controlled by a control circuit, which mode of operation is described later below.

In the above examples, the aperture is in a rearward portion of the roof. The aperture may be in forward position in the roof. However in the particular example mountings of FIGS. 5e and 5f, and 5g, the rearward position of the aperture means that the sliding panel 112 is easily accommodated inside the trap housing, in the front half thereof, as shown in FIG. 5f. Sliding versions of the panel are not limited to this arrangement, however. The panel could be arranged to pass out, at least partially, of the housing through a slot in the housing, or could be arranged to slide down behind mounting plate 208.

The light optimization panel 112 of the embodiment above, and more generally, can be positioned open or closed, or be removed entirely, or even positioned intermediate fully open and closed positions, by an installation engineer when the trap is fitted at a site. The installation engineer may take this decision based on the nature of the environment at the site, taking into account, for example, where insects are, or may come, from and where people are likely to be.

In other embodiments, the light optimization panel(s) may be positioned in a different location from the embodiment above, for example in one or both of the side panels or in the bottom of the housing. These positions emit light sideways or downwards from the trap. In order to protect people's eyes, a shield panel can be provided, projecting out from the housing and covering the aperture of the light optimization panel at least from view. The light optimization panel can be arranged to provide this shield panel, for example by the light optimization panel being hinged to its aperture along its front edge. That is to say when this panel is in the closed position it blocks the aperture and when it is open it provides a shield hiding the aperture from view.

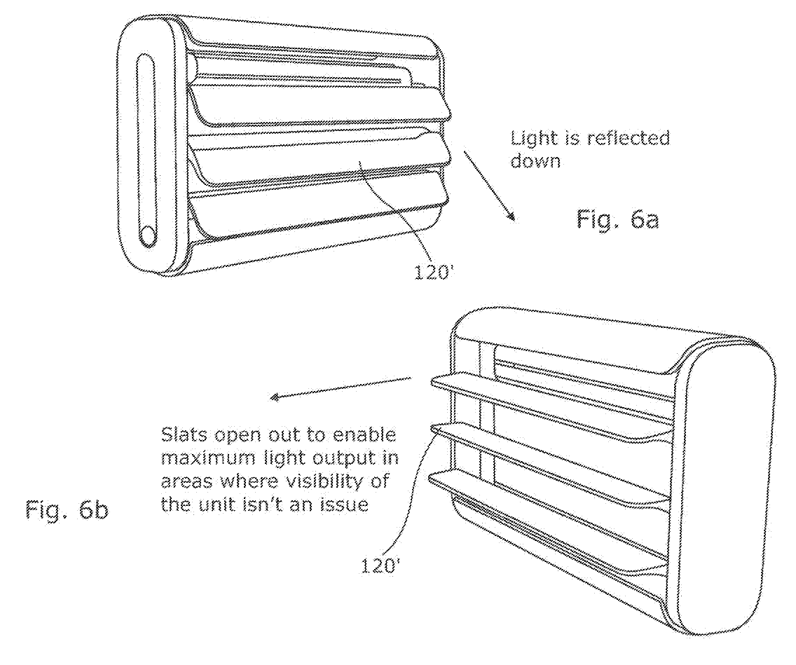

FIGS. 6a and 6b show perspective front views of a second embodiment of the insect light trap of the invention, in first and second configurations respectively. In this embodiment is generally similar to the first embodiment above and preferably has a similar light source and mount and is also provided with louvres 120′ in the front panel. In this embodiment, the louvres forming the front panel of the enclosure are mounted to pivot about a horizontal axis parallel to the front of housing and can be set at different angles. In some embodiments, these may be different angles for each louvre, but preferably and in this embodiment, they can only be set at the same angle, there being a mechanical linkage between them.

When, for example installing the insect light trap the louvres can be adjusted to overlap and obscure from view the light source when viewed from a selected position, for example a position below the insect light trap. The position shown in FIG. 6a shows the light directed down, which may be useful if the insect light trap although high on a wall is in a large room where the front may be seen from a distance. FIG. 6b shows a horizontal position, creating a large angle of light emission and hence increased attraction of insects. This in general is useful where the light being directly visible is not an issue, but nonetheless will obscure the lamps from view where a person is below and close to the trap.

FIGS. 6a and 6b do not show a light optimization panel as provided in the first embodiment but this is possible.

Further both the louvres and the light optimization panel may be driven to different positions by an actuator, for example, a motor, and a control circuit, in a manner to be described later below.

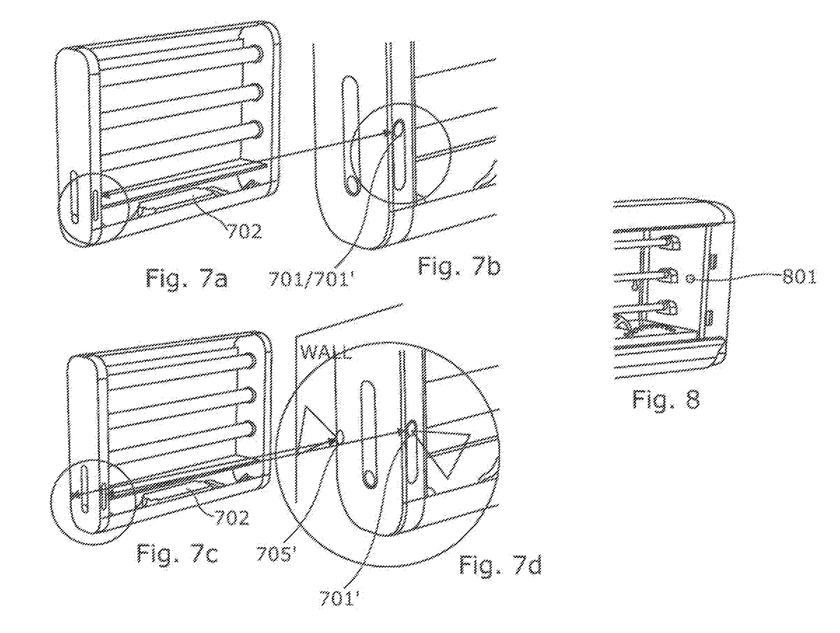

FIGS. 7a and 7b show perspective front views of third embodiment of an insect light trap according to the invention. This is generally similar to the first and second embodiments and preferably has a similar light source and mount. FIG. 7b is a detail of the lower left front corner of the insect light trap. In this embodiment, the insect light trap has been provided with a visible light level sensor 701. This is provided in a trench on the left panel 104 on the front face. This position allows it to measure the visible light level for the ambient level in the room where the insect light trap is installed, without the sensor being swamped by light emitted by the light source of the trap.

The trap is provided with an electronics unit 702 comprising a power supply, to convert mains power to voltages suitable to drive the lamps, and a control circuit. The control circuit is connected to the visible light sensor 701 to receive a signal therefrom indicating the level of ambient light. In this embodiment, the control circuit is arranged to respond to the ambient light level detected to change the level of light output by the light source. In daylight conditions, the control circuit is arranged to drive the lamps to provide a high level of light output. This provides a good level of light level contrast (in the vision of the insect) between the insect light trap and objects in its environment, allowing the trap to attract and therefore capture insects. In lower light level conditions, the control circuit is arranged to drive the lamps to provide a lower level of light output than the high level used for daylight conditions. Lower light level still provides adequate contrast between the insect light trap and the surrounding objects to provide sufficient attraction to insects to provide a reasonable effectiveness in attracting and capturing insects. However, as the lamps are driven at a lower level, less power is used, which provides a financial saving in the electricity consumed and is environmentally friendly.

The control circuit may be arranged to vary the light level output by the light source in various ways in response to the ambient light level, for example, continuously, or in one or more discrete steps as the ambient light level passes a respective threshold level.

The control circuit may drive the light source in various ways to vary the level of power output by the light source, for example, varying the level of power by one or more of the lamps, or where the light source comprises a plurality of the separate lamps by turning off and on particular ones of the lamps, so that different numbers of the lamps are providing light.

In other embodiments the control circuit is connected, as well as or instead controlling the lamps, to control the position of the louvres and/or light control panel, in response to the visible light level sensor 701. This control circuit may be arranged to provide various functions in controlling the louvres and/or light optimization panel. In one such embodiment, the louvres and/or light optimization panel are set by the control circuit to different positions in response the signal from the visible light level sensor selected according to the likelihood of people being around. So, for example, in one such arrangement, in higher lighting levels of the day the louvres are positioned to obscure the view of the lamps, in lower lighting levels at night and the lighting for the room has been switched off the louvres are positioned to give maximum exposure. The control circuit in one example may be arranged to open the light optimization panel in mid lighting conditions at night when the room lights are on or are low—which could be for aesthetic reasons that lamp light projected on the wall looks attractive to people.

Ambient visible light sensors that can cope with a wide range of visible light levels from full sunlight down to a dark night are readily available.

In this third embodiment, where the light source provides UV illumination using a visible light level sensor is useful because the ambient UV in the room, or other location, does vary with the ambient visible light level.

Table 1 below shows a particular example, where different powers are used at different times of day, in response to the ambient visible light levels at those times of day. The example is for a light source of the trap being six UV LEDs being driven by the control circuit at the currents indicated.

TABLE 1

| Time of | Ambient Light | Drive | Lamp | Running |
|---|---|---|---|---|
| day | Level | Current | Power | Cost |
| Daytime | High | 500 mA | 11.4 W | High |
| Evening | Medium | 375 mA | 9.55 W | Medium |
| Night | Low | 250 mA | 5.7 W | Low |

FIGS. 7a and 7b also show a fourth embodiment of an insect light trap according to the invention. This is as the third embodiment but instead of the visible light sensor it has, in the same position, a UV light level sensor 701′. Being in the trench this is responsive to UV light levels in the room, or other location, in which the trap is installed. Also in this embodiment, the light source of the insect light trap is a UV light source. With a UV light source walls, the ceiling or objects in the room, or other location in which the trap is installed, can emit significant levels of UV light as a result of reflection or scattering by those items of UV light emitted by the insect light trap. For example, white walls and stainless steel kitchen work surfaces can scatter or reflect high levels of UV light. These levels can be higher than ambient UV levels or those from other sources of UV in the location.

In this embodiment, the electronics unit 702 again comprises a power supply, to convert mains power to voltages suitable to drive the UV light source, and the control circuit. The control circuit is connected to the UV light sensor 701′ to receive a signal therefrom indicating the level of UV light from the room. The control circuit is arranged to respond to the UV light level detected from the room to change the level of UV light output by the light source. If the level of UV light detected is high, the control circuit is arranged to drive the light source to provide a high level of UV light output. This provides a good level of UV light level contrast between the insect light trap and objects, or walls, etc., in its environment, allowing the trap to attract and therefore capture insects. When a lower level of UV light level is detected by sensor 701′ the control circuit is arranged to drive the UV lamps to provide a lower level of UV light output than the high level mentioned above. The lower UV light level still provides adequate UV contrast between the insect light trap and the surrounding objects to provide sufficient attraction to insects to provide a reasonable effectiveness in attracting and capturing insects. However, as the lamps are driven at a lower level, less power is used, which provides a financial saving in the electricity consumed and is environmentally friendly.

Again, in other embodiments the control circuit is connected, as well as or instead controlling the lamps, to control the position of the louvres and/or light control panel, in response to the UV light level sensor 701′. This control circuit may be arranged to provide various functions in controlling the louvres and/or light optimization panel. Again in one such embodiment the louvres and/or light optimization panel are set by the control circuit to different positions in response the signal from the UV light level sensor selected according to the likelihood of people being around (although of course in this case there will be less sensitivity to room lighting, which has little UV content). In another embodiment, the control circuit controls both the light level output by the lamps and the position of the louvres and/or light optimization panel to achieve a selected UV surrounding lighting level from the trap. In one such example, the control circuit tries various positions of the louvres and light optimization panel and sets them finally at the position giving the highest signal from the UV light level sensor.

UV light level sensors are also readily available.

Table 2 below shows a particular example, where different powers are used, in response to the detected UV light levels. The example is for a light source of the trap being six UV LEDs being driven by the control circuit at the currents indicated.

TABLE 2

| UV Light Level | Drive | Lamp | Running |
|---|---|---|---|
| Detected | Current | Power | Cost |
| High | 500 mA | 11.4 W | High |
| Medium | 375 mA | 9.55 W | Medium |
| Low | 250 mA | 5.7 W | Low |

FIGS. 7c and 7d are front perspective views of a fifth embodiment of the invention. This is generally as the fourth embodiment, however this is provided with a second UV light sensor 705′ in addition to the UV light sensor 701′. Second UV light sensor 801 is mounted to have a different view of the room, or other location in which the trap is mounted; in this particular example, the second UV light sensor is mounted recessed in the side panel 104 of the trap and has a view in the direction perpendicular to the side panel. The second UV light sensor is as shown preferably mounted to the rear of the side panel so that its view of the area in front of the font panel of the trap is, to some extent at least, obscured by the side panel 104. The control circuit is connected to receive respective signals from the UV light sensors 701′ and 705′ representing the UV light levels detected by them from their respective views, and in response control the light output levels of the lamps and/or the positons of the louvres and/or light optimization panel. Various control functions may be implemented by the control circuit. In one such embodiment, the lighting level is adjusted that a selected minimum UV light level from the surroundings from each of UV light sensors is achieved. (Those minimums may be the same or respective ones.) In an example of that the control circuit also controls the louvres and or light optimization panel to achieve that, for example by selecting various positions for those and selecting one that brings the signals from the two UV light sensors into roughly the same ratio with their respective selected minimums and then the control circuit adjusts the power output by the light source until the minimums, or some selected point above that are reached. In other such embodiments the control circuit judges the overall UV light returned from the surroundings in the manner of Table 2 but with that returned UV light level being taken as a combination of the signals from the two UV light level sensors, such as a weighted average.

FIG. 8 is a perspective view of a sixth embodiment of the invention. This is generally as the previous embodiments. However, this is provided with an output monitoring UV light sensor 801 mounted on the insect light trap to have a view of the light source of the insect light trap. In this particular example the output monitoring UV light sensor 801 is mounted in the inside of the side panel 105 facing inwards to towards the UV lamps. The output of both fluorescent and LED UV lamps declines with time. The output of fluorescent UV lamps usually drops by 30% from the original value after 12 months, at which point they are usually replaced. LED UV lamps last longer but their output level also declines with time. In this embodiment, the control circuit 702 is connected to receive a signal from the output monitoring UV sensor 801 indicating the level of UV light that it receives. Since the view of sensor 801 is primarily of the lamps of the insect light trap its signal indicates the level of output of the UV lamps. In another embodiment, the UV sensor is located alternatively in the front panel, looking back to the lamps.

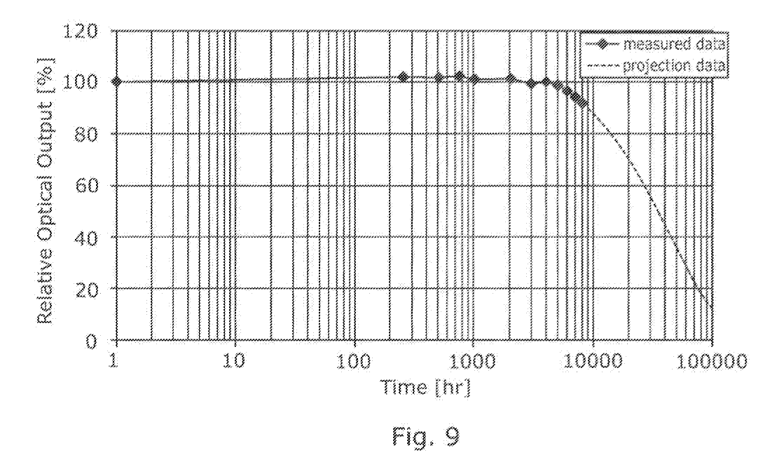

FIG. 9 is a graph showing the typical performance over time of a LED UV lamp against time with the vertical axis being the relative output compared to the initial light level output. This shows that the output is stable for a long initial period before declining. In this case, a lifetime of 19800 hours is expected for the particular LED UV lamp measured, with the definition of this lifetime being when the output drops by 30% from the original level.

The control circuit 702 is arranged to be responsive to the signal from the UV light sensor 801 to control the drive provided to the lamp to compensate for a drop in output by increasing the level of the drive. In this embodiment, the circuit has a feedback arrangement, increasing the drive until a target level of UV level reaches a desired level. The target level out UV light output may be a preset level. Another way to set that level is for the control circuit to record the level of UV light output at a preset level of drive when the lamp is first fitted and to record the UV level measured, or a value derived therefrom (for example a multiple or a fraction thereof) as the target level for subsequent light output. This may prevent overdriving lamps that produce initially a little less UV light than other similar lamps.

In another embodiment control circuit 702 is arranged to set the drive the lamps with a test level of drive level from time to time (for example daily) and to record the level of UV light output in that condition, using sensor 801. The control circuit is provided with a predetermined lookup table in which it looks up the level of the drive to use for each level of recorded UV output level and adjusts the drive to that level for subsequent operation. The look up table is determined experimentally by the insect light trap manufacturer using test samples of the lamps to be used.

The insect light trap may further be provided with a data connection communication, for example an Internet connection, to a server computer of an insect light trap service company. The control circuit is arranged to record and monitor the data of either the light levels measured at the test drive level or the drive level being used to maintain the output UV light level at the target level and when that has reached a point at which the light source should be replaced it sends an indication of that to a server of the service company, which can then take action to schedule a replacement of the light source. Alternatively, the data may be sent by the insect light trap to the server, which performs the said monitoring to determine whether replacement of the light source is needed.

This process allows correct replacement of UV lamps based on output rather than replacement after a specified time or manual measurements being required with special equipment. This invention will provide cost and efficiency saving in through life costs.

What is claimed is:

1. An insect light trap comprising:
a housing, comprising:
an aperture; and
a light source inside the housing for emitting insect attracting light through the aperture,
wherein the housing has a panel movable between at least a first position and a second position in which it obstructs, or guides, the light from the light source passing through the aperture differently from in the first position; and
an actuator mounted to move the panel between the first position and the second position in response to a control signal,
a first light level sensor connected to provide a first light level signal indicating a first light level received from outside the housing of the insect light trap; and
a control circuit connected to receive the first light level signal and responsive thereto to provide the control signal to the actuator to move the panel.

2. The insect light trap according to claim 1, wherein the panel comprises one or more louvres.

3. The insect light trap according to claim 1, wherein the panel comprises two or more louvres.

4. The insect light trap according to claim 2, wherein the aperture and the panel are on a front side of the insect light trap.

5. The insect light trap according to claim 1, wherein the aperture and the panel are in a top side, a left or right side, or a bottom side of the insect light trap.

6. The insect light trap according to claim 5, wherein the aperture is in a front side of the insect light trap and configured to allow light from the light source to pass out of the insect light trap.

7. The insect light trap according to claim 1, wherein the light source is an ultra violet (UV) light source.

8. The insect light trap according to claim 1, wherein the first light level sensor is a visible light level sensor and the first light level signal indicates a visible light level.

9. The insect light trap according to claim 1, wherein the first light level sensor is an ultra violet (UV) light level sensor and the first light level signal indicates a UV light level.

10. The insect light trap according to claim 1, further comprising:
a second light level sensor configured to provide a second light level signal indicating a second light level received from outside the housing of the insect light trap,
wherein the control circuit is responsive to the second light level signal to provide the control signal to the actuator to move the panel.
